(19) United States
(12) Patent Application Publication
(10) Pub. No.: US 2009/0204648 A1
(43) Pub. Date: Aug. 13, 2009

(54) TRACKING METADATA FOR FILES TO AUTOMATE SELECTIVE BACKUP OF APPLICATIONS AND THEIR ASSOCIATED DATA

(76) Inventors: Steven Francie Best, Georgetown, TX (US); Robert James Eggers, JR., Austin, TX (US); Janice Marie Girouard, Austin, TX (US); Emily Jane Ratliff, Austin, TX (US)

Correspondence Address: IBM CORP (YA);C/O YEE & ASSOCIATES PC, P.O. BOX 802333, DALLAS, TX, 75380, US

(21) Appl. No.: 12/028,968

(22) Filed: Feb. 11, 2008

(51) Int. Cl. G06F 17/30

(52) U.S. Cl. 707/204; 707/E17.007

(57) ABSTRACT

A computer implemented method, a data processing system, and a computer program product backup an application and a file for the application. A set of backup parameters is received. The backup parameters include an indication of the application to be backed up. Responsive to receiving the backup parameters, a metadata indicator associated with the application is identified. A set of files associated with the metadata indicator is then identified. The set of files and the application are then forwarded to a backup storage for backup.

### BACKGROUND OF THE INVENTION

1. Field of the Invention

The present invention relates generally to computer implemented methods, data processing systems, and computer program products. More specifically, the present invention relates to a computer implemented method, a data processing system, and a computer program product for backing-up applications and files for those applications.

2. Description of the Related Art

In an electronic filing system, a directory is an organizational entity may hold or contain a group of files and possibly other subdirectories. Because a typical filing system may contain thousands of files, files are organized by storing related files in the same directory. The directories and subdirectories located within an electronic filing system form a hierarchical structure. Files within the electronic filing system are then located by navigating the various directories until the file is reached. The pathway through the directories to the file is the “path address” of the file.

A computer file is a block of information, or a block available for storing information, accessible or usable, by a computer program. Individual files are the final nodes in the hierarchical tree structure of an electronic filing system.

When an unexpected loss of data occurs, backup utilities restore directories and the files located therein to pre-loss state. Current backup systems backup entire directories including each file therein. In order to backup specific files, a directory containing those specific files must be selected for backup. Therefore, when users back up a file system, they are forced to select directories which are to be backed up.

Many users are unconcerned with the structure of the electronic filing system, as well as the navigation and hierarchy employed by the filing system. Many novice users have no idea what a directory is, or what directory individually houses the individual files in which the user might be interested. Thus, when these users are forced to navigate an electronic filing system in order to designate specific directories for backup, files intended for backup are often missed, resulting in lost files.

### SUMMARY OF THE INVENTION

A computer implemented method, a data processing system, and a computer program product for backing-up an application and a file for that application are described. A set of backup parameters is received. The backup parameters include an indication of the application to be backed up. Responsive to receiving the backup parameters, a metadata indicator associated with the application is identified. A set of files associated with the metadata indicator is identified. The set of files and the application are then forwarded to a backup storage for backup.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a data flow diagram through the various software components according to an illustrative embodiment;

FIG. 4 is a data flow diagram for a backup process of selected applications according to an illustrative embodiment;

FIG. 5 is an illustration of a file system for indicating historical access to a file according to an illustrative embodiment;

FIG. 6 is a high level flowchart illustrating the processing of data according to an illustrative embodiment;

FIG. 7 is a flowchart illustrating the processing of data utilizing a file path as an indicator according to an illustrative embodiment; and

FIG. 8 is a flowchart illustrating the processing steps of editing metadata associated with a file in an electronic filing system according to an illustrative embodiment.

### DETAILED DESCRIPTION OF THE PREFERRED EMBODIMENT

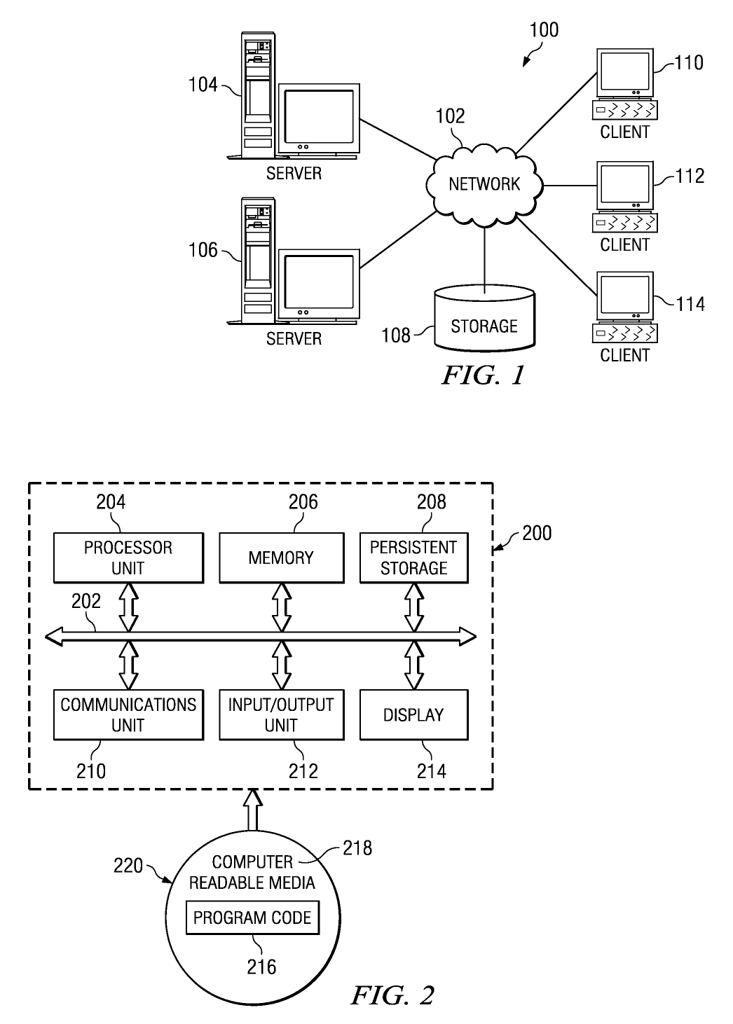

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown. According to the illustrative embodiments, server 104 and server 106 can provide clients 110, 112, and 114 with backup storage backup services to backup files contained on clients 110, 112, and 114.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The illustrative embodiments describe an electronic filing system wherein a unique metadata indicator is associated with each file. The metadata indicator can indicate which applications have been used to access certain files. As used herein, a metadata indicator is a set of historical identifiers denoting which applications have accessed that particular file. A set refers to one or more items. For example a set of historical identifiers is one or more historical identifiers. In one illustrative embodiment, the metadata can be a linked list. When an application opens or utilizes a certain file, the linked list for that file is appended to include an identifier of the application opening or utilizing the file.

Backup utilities can then search a known or specified disk or directory structure for the metadata indicator, and thus identify all of those files that have been accessed by an application. The backup utility then backs up the application itself, and all of the associated files.

The different embodiments provide a computer implemented method, a data processing system, and a computer program product for backing-up an application and a file for the application. A set of backup parameters is received. The backup parameters include an indication of the application to be backed up. Responsive to receiving the backup parameters, a metadata indicator associated with the application is identified. A set of files associated with the metadata indicator is then identified. The set of files and the application are then forwarded to a backup storage for backup.

Additionally, the described backup system can include all application and data files associated with a certain software package, from which the specified application was originally extracted. For example, if the user requests a backup of an e-mail utility that was originally extracted from an e-mail software package, the backup system could backup all files extracted from the e-mail software package, including installation, execution, or runtime files that are utilized by the specified application.

The illustrative embodiments could be utilized in conjunction with known backup systems, such as incremental backup systems. The known techniques would simply be layered on top of the file selection process of the illustrative embodiments.

While known systems can be summarized as “a collection of directories saved to disk”, the illustrative embodiments provide “a collection of applications and their associated data files saved to disk”. Furthermore, the end user of the illustrative embodiments is not required to have a complete knowledge of the applications and the application directory structure in order to backup desired files.

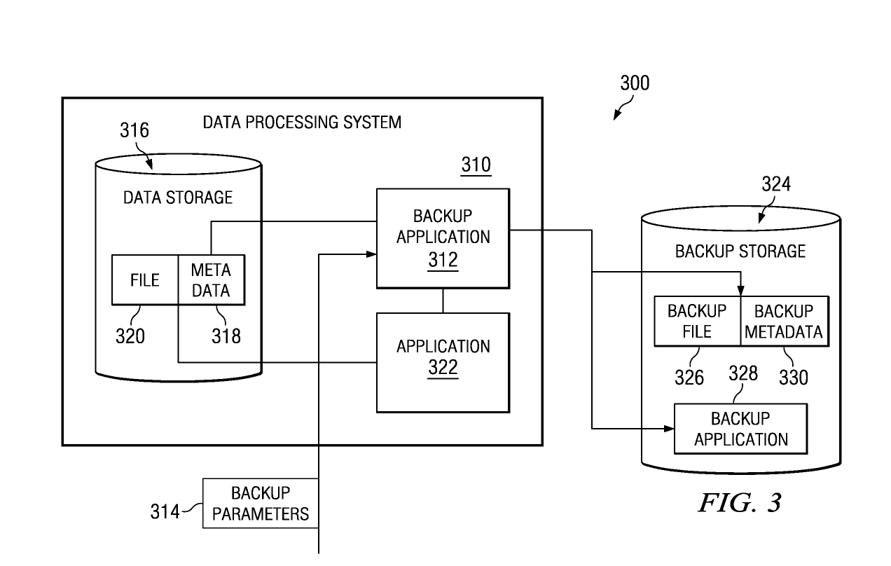

Referring now to FIG. 3, a data flow diagram of data flow through the various software components is shown according to an illustrative embodiment. Data processing system 300 of FIG. 3 is a data processing system, such as server 104 and server 106 and Clients 110, 112, and 114 of FIG. 1.

Backup application 312 is a software component executing on data processing system 310. Backup application 312 performs backup operations, making periodic copies of data files and applications. These additional copies can then be used to restore an original version of the data files and applications in the event of an unforeseen loss of the data files or applications. Backup application 312 also edits metadata 318.

A user enters backup parameters 314 into backup application 312. Backup parameters 314 are an indication of which applications and data files are to be backed up by backup application 312. Backup parameters 314 can also be one or more default parameters received in a file. Backup parameters 314 can also be set by a program. In one illustrative embodiment, a graphical user interface can present a list of known applications installed on data processing system 310 to a user. The user can then select the applications that are to be backed up from the list, thus providing an indication from backup parameters 314 to backup application 312.

Responsive to receiving backup parameters 314, backup application 312 parses data storage 316 to identify which files within data storage 316 have metadata 318 that indicates the applications to be backed up. Metadata 318 is an indication of which data files, such as file 320, have been accessed by a certain application, such as application 322.

Metadata 318 can be an indicator, such as a bit, a flag, a file extension, a byte string, or other indicator associated with individual data files, designating that a certain data file is utilized by or is accessed by a given application. Metadata 318 can also be an entry into a data structure, wherein metadata 318 is associated with a data file within the data structure, thus indicating that the data file is utilized by a given application, or that the application has accessed the data file. In one illustrative embodiment, the metadata 318 can be a linked list. When an application opens or utilizes a certain file, backup application 312 appends the linked list for that file to include an identifier of the application opening or utilizing the file.

Each file within the electronic filing system, such as file 320 is associated with its own unique metadata, such as metadata 318. File 320 is a data file within an electronic filing system that is utilized by or is accessed by application 322. File 320 can be a data file created by application 322. In a non-limiting example, file 320 can be a data processing document created by a data processing application. File 320 can also be an installation, execution, runtime, or some other suitable type of file utilized by application 322 during installation or execution. File 320 can be a set of files, the set of files including at least one file. Each file within the set of files can be associated with its own unique metadata, such as metadata 318. Each unique metadata provides for its associated file a historical identification of the files that have accessed or utilized that particular file.

In another illustrative embodiment, metadata 318 can be an indicator that is associated with a software package. Upon installation, or extraction of the software package, backup application 312 appends metadata for each file associated with the package to include an indication of the application that accesses the file. That is, upon installation, a metadata for each installed or extracted file, such as metadata 318, is appended to include those applications that have access to the installed or extracted file. Therefore, each file associated with the software package can be readily identified by identifying metadata 318 of those files that contain or are tagged with applications from the software package.

Application 322 is a software component stored on or accessed by data processing system 310. Application 322 creates, accesses, or otherwise utilizes file 320.

Responsive to identifying that metadata 318 associated with file 320 indicates application 322 which is to be backed up, backup application 312 forwards file 320 and application 322 to backup storage 324. Backup storage 324 is a data storage separate from data storage 316 that contains a backup copy of data files and applications that may be used to restore an original version of data files and applications in the event of an unforeseen loss. Backup storage 324 can be a physical storage device separate from data storage 316, and can be a persistent or volatile media, such as a hard disk drive, a read only memory, a random access memory. Backup storage 324 can be a removable media, such as a CD-ROM, a flash memory, a removable disk. Backup storage 324 can also be a partitioned section of data storage 316.

File 320 is stored as backup file 326 within backup storage 324. Backup file 326 is a copy of file 320 made at the time of performing the backup. Backup file 326 can then be used to restore file 320 to a known working state. Application 322 is stored as backup application 328. Backup application 328 is a copy of application 322 made at the time of performing the backup. Backup application 328 can then be used to restore application 322 to a known working state.

Additionally, metadata 318 can also be stored within backup storage 324 as backup metadata 330. By storing backup metadata 330 in backup storage 324, metadata 318 can be restored in the event of a loss. The restoration of metadata 318 allows backup application to continue functioning in subsequent backups of file 320 and application 322 after recovery from a loss.

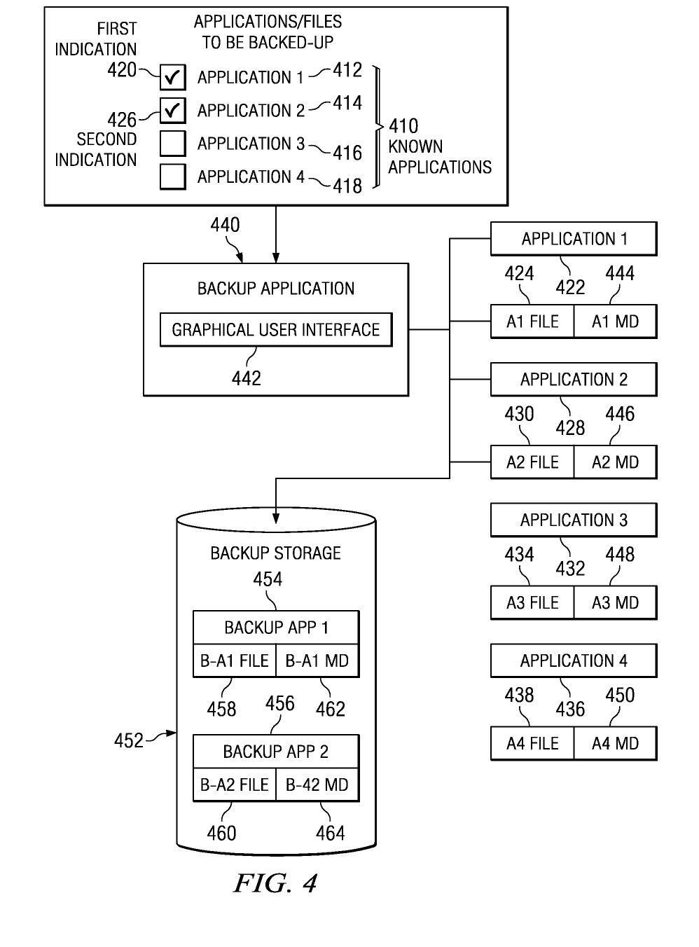

Referring now to FIG. 4, a data flow diagram of a backup process of selected applications is shown according to an illustrative embodiment. The data flow of FIG. 4 is a more detailed depiction of the data flow of FIG. 3, indicating the selection of various known applications which are to be backed up by the backup application.

In this illustrative example, a user is presented with a list of known applications 410. List of known applications 410 includes names, or other identifiers of applications, such as application 322, on a data processing system, such as data processing system 310 of FIG. 3. List of known applications 410 include application 1 name 412, application 2 name 414, application 3 name 416 and application 4 name 418. While in this illustrative example the list of known applications includes four (4) applications, the list of known applications can comprise any number of known applications.

The user then indicates which applications from a list of known applications 410 should be backed up by backup application 440. In this illustrative embodiment, the user provides first indication 420 designating that application 1 422 should be backed up, as well as files associated with application 1 422, such as application 1 file 424. Furthermore, the user provides second indication 426 designating that application 2 428 should be backed up as well as files associated with application 2 428, such as application 2 file 430. The user has not indicated that application 3 432 and the associated application 3 file 434 should be backed up. Similarly, the user has not indicated that application 4 436 and the associated application 4 file 438 should be backed up.

First indication 420 and second indication 426 can be provided to backup application 440 though a user selection from graphical user interface 442. Graphical user interface 442 is an interface which allows a user to interact with backup application 440 through the manipulation of graphical indicators. Backup application 440 can be backup application 312 of FIG. 3.

Responsive to receiving first indication 420 and second indication 426, backup application 440 identifies application 1 422 and application 2 428. To accomplish this identification, Backup application 440 identifies which files within the electronic filing system have metadata indicating that application 1 422 or application 2 428 to be backed up has accessed that file.

When parsing a data storage, such as data storage 316 of FIG. 3, backup application 440 identifies metadata indicating that an associated file has been accessed by or has been utilized by application 1 422. Backup application 440 thus identifies application 1 metadata 444 as indicating that application 1 file 424 has been accessed by or utilized by application 1 422. Application 1 file 424 can be file 320 of FIG. 3.

In one illustrative embodiment, metadata can be a linked list. Backup application 440 can traverse the linked list of each file within the electronic filing system to determine which of those file's metadata contain an indication of an application to be backed up. That is, having received an indication that application 1 422 is to be backed up, backup application 440 traverses the linked list for each of application 1 file 424, application 2 file 430, application 3 file 434, and application 4 file 438 to determine which, if any, linked list indicates that application 1 422 has accessed that file. Backup application 440 identifies an indication of application 1 422 in the linked list of application 1 file 424. That is, application 1 metadata 444 contains an indication that application 1 file 422 has been accessed by or has been utilized by application 1 422.

Additionally, when parsing a data storage, such as data storage 316 of FIG. 3, backup application 440 identifies metadata indicating that an associated file has been accessed by or has been utilized by, application 2 428. Backup application 440 thus identifies application 2 metadata 446 as indicating that application 2 file 430 has been accessed by or utilized by application 2 428. Application 2 file 430 can be file 320 of FIG. 3.

In this illustrative embodiment, the user did not include an indication of application 3 name 416 or application 4 name 418 from list of known applications 410. Therefore, backup application 440 does not search for an indication in the metadata of files within the electronic filing system indicating if files have been accessed by application 3 432 or application 4 436. Application 3 metadata 448 indicates that application 3 file 434 has been accessed only by application 3 432. Application 4 metadata 450 indicates that application 4 file 438 has been accessed only by application 4 436. Therefore, application 3 file 434 and application 4 file 438 are not identified for backup by backup application 440.

If application 3 metadata 448 had indicated that either of application 1 422 or application 2 428 had accessed, or otherwise utilized application 3 file 434, then application 3 file would have been selected for backup. Likewise, if application 4 metadata 450 had indicated that either of application 1 422 or application 2 428 had accessed, or otherwise utilized application 4 file 438, then application 4 file 438 would have been selected for backup.

Responsive to identifying that application 1 metadata 444 and application 2 metadata 446 indicate access by application 1 422 and application 2 428 respectively, backup application 440 forwards application 1 file 424 and application 2 file 430 to backup storage 452. Backup storage 452 can be backup data storage 322 of FIG. 3. Additionally, backup application 440 forwards application 1 422 and application 2 428 to backup storage 452.

Application 1 422 is stored as backup application 1 454. Backup application 1 454 is a copy of application 1 422 made at the time of performing the backup, which can be used to restore application 1 422 to a known working state. Application 2 428 is stored as backup application 2 456. Backup application 2 456 is a copy of application 2 428 made at the time of performing the backup, which can be used to restore application 2 428 to a known working state.

Application 1 file 424 is stored as backup application 1 file 458. Backup application 1 file 458 is a copy of application 1 file 424 made at the time of performing the backup, which can be used to restore application 1 file 424 to a known working state. Application 2 file 430 is stored as backup application 2 file 460. Backup application 2 file 460 is a copy of application 2 file 430 made at the time of performing the backup, which can be used to restore application 2 file 430 to a known working state.

Additionally, application 1 metadata 444 and application 2 metadata 446 can also be stored within backup storage 452 as backup application 1 metadata 462 and backup application 2 metadata 464 respectively. By storing backup application 1 metadata 462 and backup application 2 metadata 464 in backup storage 452, application 1 metadata 444 and application 2 metadata 446 can be restored in the event of a loss. The restoration of application 1 metadata 444 and application 2 metadata 446 allows backup application 440 to continue functioning in performing subsequent backups of application 1 422, application 2 428, application 1 file 424, and application 2 file 434 after recovery from a loss.

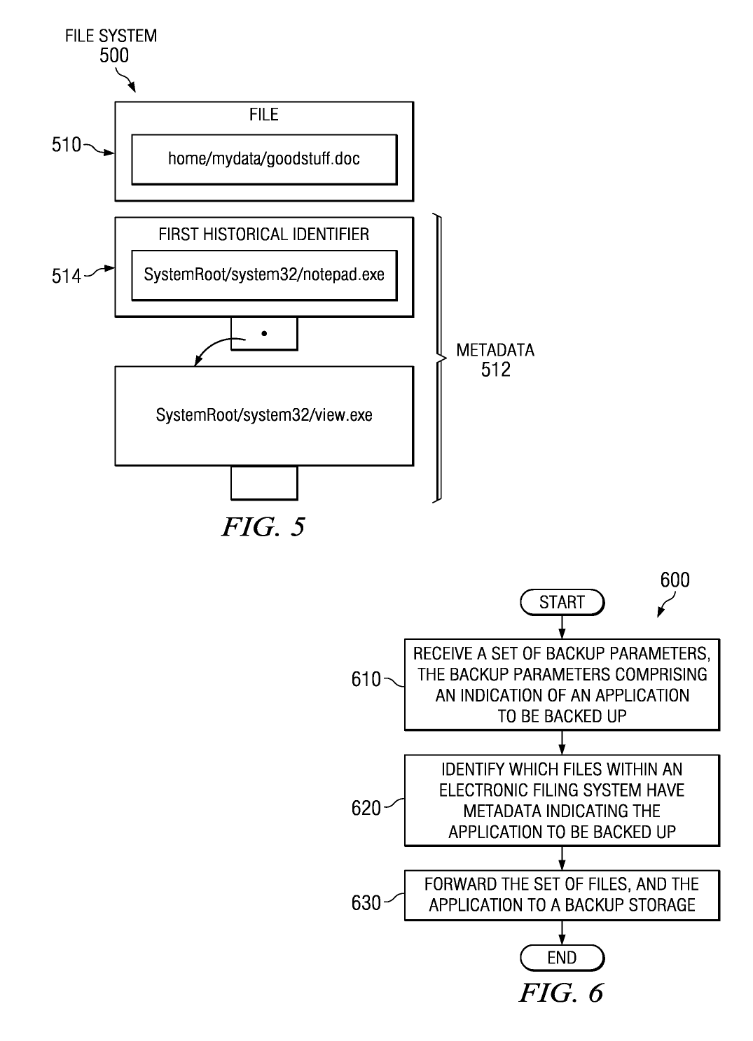

Referring now to FIG. 5, a file system for indicating historical access to a file is shown according to an illustrative embodiment. In the present illustrative example, file system 500 is shown as utilizing a linked list. However, file system 500 can also utilize other indicators capable of recording the historical access to files. Such indicators may include, but are not limited to, other data structures, a bit, a flag, a file extension, a byte string, or other indicators associated with individual data files, designating that a certain data file is utilized by or is accessed by a given application.

File system 500 includes file 510. File 510 can be file 320 of FIG. 3. File 510 has a file path within the electronic filing system of “/home/mydata/goodstuff.doc”. Associated with file 510 is metadata 512. Metadata 512 can be metadata 318 of FIG. 3.

Metadata 512 is comprised of a set of historical identifiers indicating the applications that have accessed, or otherwise utilized file 510. First historical identifier 514 indicates that a first application, such as application 1 422 of FIG. 4, has accessed, or otherwise utilized file 510. Metadata 512 is therefore appended to include an identifier of the first application opening or utilizing the file 510.

In the present illustrative example, the file path of the application accessing file 510 is used as an identifier. The first application accessing file 510 has a file path of “SystemRoot/system32/notepad.exe”. First historical identifier 514 is therefore appended to metadata 512 to indicate that the first application has accessed, or otherwise utilized file 510.

Responsive to a second application, such as application 2 428 of FIG. 4, accessing or otherwise utilizing file 510, metadata 512 is appended to include second historical identifier 516 of the second application. In the present illustrative example, the file path of the application accessing file 510 is used as an identifier. The second application accessing file 510 has a file path of “SystemRoot/system32/view.exe”. Second historical identifier 516 is therefore appended to metadata 512 to indicate that the second application has accessed, or otherwise utilized file 510.

Referring now to FIG. 6, a high level flowchart illustrating the processing of data is shown according to an illustrative embodiment. Process 600 is a software process, executing on a software component, such as backup application 312 of FIG. 3.

Process 600 begins by receiving a set of backup parameters, the backup parameters comprising an indication of an application to be backed up (step 610). The backup parameters are an indication of which applications and data files are to be backed up by process 600. In one illustrative embodiment, a graphical user interface presents a list of known applications installed on a data processing system to a user. The user can then select applications that are to be backed up from the list, thus providing an indication from the backup parameters to process 600.

Process 600 identifies which files within an electronic filing system have metadata indicating the application to be backed up (step 620). Process 600 can parse a data storage to identify metadata for a file or files, such as metadata 318 of FIG. 3. The metadata is an indication of which data files, such as file 320 of FIG. 3, have been accessed by a certain application, such as application 322 of FIG. 3. The metadata can be an indicator, such as a bit, a flag, a file extension, a byte string, or other indicator associated with individual data files.

The metadata designates that a certain data file is utilized by, or is accessed by, a given application. The metadata can also be an entry into a data structure, such as a linked list, wherein the metadata is associated with a data file within the data structure, thus indicating that the data file is utilized by a given application, or that the application has accessed the data file.

Process 600 then forwards the set of files, and the application to a backup storage (step 630), with the process terminating thereafter. The set of files is stored as a backup set of files within the backup storage. The backup set of files is a copy of the set of files made at the time of performing the backup. The backup set of files can then be used to restore the set of files to a known working state.

The application is stored as a backup application. The backup application is a copy of the application made at the time of performing the backup. The backup application can then be used to restore the application to a known working state.

Additionally, the metadata can also be stored within the backup storage as a backup metadata. By storing the backup metadata in the backup storage, the metadata can be restored in the event of a loss. The restoration of the metadata allows the backup application to continue functioning for subsequent backups of the set of files and the application after recovery from a loss.

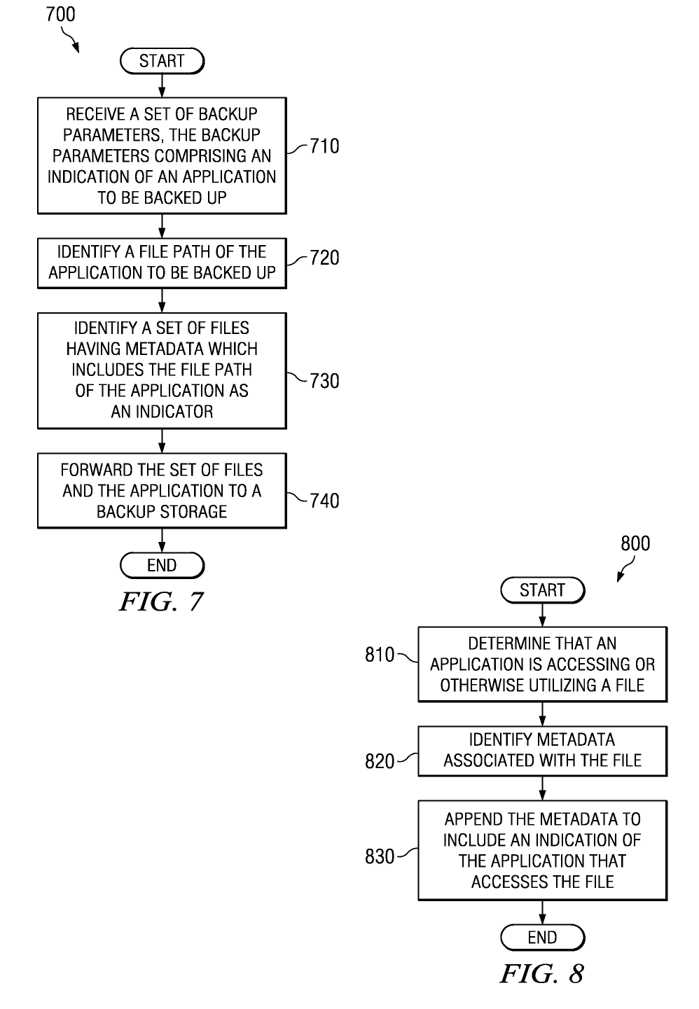

Referring now to FIG. 7, a flowchart illustrating the processing of data utilizing a file path as an indicator is shown according to an illustrative embodiment. Process 700 is one illustrative embodiment of process 600 of FIG. 6. Process 700 is a software process, executing on a software component, such as backup application 312 of FIG. 3.

Process 700 begins by receiving a set of backup parameters, the backup parameters comprising an indication of an application to be backed up (step 710). The backup parameters are an indication of which applications and data files are to be backed up by process 700.

Responsive to receiving the set of backup parameters, process 700 identifies a file path of the application to be backed up (step 720). The file path of the application is utilized as an indication of which data files, such as file 320 of FIG. 3, have been accessed by a certain application, such as application 322 of FIG. 3. That is, metadata of those files accessed by a certain application utilize the file path of that application as an indicator to associate the accessed file with the application.

Responsive to identifying the file path for the application to be backed up, process 700 identifies a set of files having metadata which includes the file path of the application as an indicator (step 730). Process 700 can parse a data storage to identify those files whose metadata includes the file path of the application. The file path of the application is an indication of which data files, such as file 320 of FIG. 3, have been accessed by a certain application, such as application 322 of FIG. 3. The file path does not resolve to the application itself, but rather serves only as an indicator or flag that the associated file is utilized by the application to be backed up. The file path can be a byte string, or other indicator associated with individual data files, designating that a certain data file is utilized by, or is accessed by, a given application. The file path can also be an entry into a data structure, wherein the file path is associated with a data file within the data structure, thus indicating that the data file is utilized by a given application, or that the application has accessed the data file.

Process 700 then forwards the set of files and the application to a backup storage (step 740), with the process terminating thereafter. The set of files is stored as a backup set of files within the backup storage. The backup set of files is a copy of the set of files made at the time of performing the backup. The backup set of files can then be used to restore the set of files to a known working state.

The application is stored as a backup application. The backup application is a copy of the application made at the time of performing the backup. The backup application can then be used to restore the application to a known working state.

Additionally, the file path can also be stored within the backup storage as a backup file path. By storing the backup file path in the backup storage, the file path can be restored in the event of a loss. The restoration of the file path allows the backup application to continue functioning for subsequent backups of the set of files and the application after recovery from a loss.

Referring now to FIG. 8, a flowchart illustrating the processing steps of editing metadata associated with a file in an electronic filing system is shown according to an illustrative embodiment. Process 800 is a software process, executing on a software component, such as backup application 312, of a data processing system 300.

Process 800 begins by determining that an application, such as application 322 of FIG. 3, is accessing or otherwise utilizing a file (step 810), such as file 320 of FIG. 3.

Responsive to determining that an application is accessing or otherwise utilizing a file, process 800 identifies metadata, such as metadata 318 of FIG. 3, associated with the file (step 820).

Responsive to identifying metadata associated with the file, process 800 appends the metadata to include an indication of the application that accesses the file (step 830), with the process terminating thereafter. The indication appended to the metadata is a historical identifier denoting the application which has accessed that file associated with the metadata.

Thus, the illustrative embodiments described herein provide an electronic filing system wherein a unique metadata indicator is associated with each file. The metadata indicator can indicate which applications have been used to access certain files. As used herein, a metadata indicator is a set of historical identifiers denoting which applications have accessed that file. In one illustrative embodiment, the metadata can be a linked list. When an application opens or utilizes a certain file, the linked list for that file is appended to include an identifier of the application opening or utilizing the file.

Backup utilities can then search a known or specified disk or directory structure for the metadata indicator, and thus identify all of those files that have been accessed by an application. The backup utility then backs up the application itself, and all of the associated files.

A computer implemented method, a data processing system, and a computer program product for backing-up an application and a file for the application are described. A set of backup parameters is received. The backup parameters include an indication of the application to be backed up. Responsive to receiving the backup parameters, a metadata indicator associated with the application is identified. A set of files associated with the metadata indicator is then identified. The set of files and the application are then forwarded to a backup storage for backup.

Additionally, the described backup system can include all application and data files associated with a certain software package, from which the specified application was originally extracted. For example, if the user requests a backup of an e-mail utility that was originally extracted from an e-mail software package, the backup system could backup all files extracted from the e-mail software package, including installation, execution, or runtime files that are utilized by the specified application.

The illustrative embodiments could be utilized in conjunction with known backup systems, such as incremental backup systems. The known techniques would simply be layered on top of the file selection process of the illustrative embodiments.

While known systems can be summarized as “a collection of directories saved to disk,” the illustrative embodiments provide “a collection of applications and their associated data files saved to a disk.” Furthermore, the end user of the illustrative embodiments is not required to have a complete knowledge of the applications and the application directory structure in order to backup desired files.

The invention can take the form of an entirely hardware embodiment, an entirely software embodiment or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modes, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for backing-up an application and a set of files for the application, the computer implemented method comprising:
receiving a set of backup parameters, wherein the set of backup parameters comprises an indication of the application;
responsive to receiving the set of backup parameters, identifying a historical indicator within metadata of the set of files, wherein the historical indicator indicates that the application has accessed the set of files; and
forwarding the set of files and the application to a backup storage.

2. The computer implemented method of claim 1, wherein the set of backup parameters further comprises:
a list of known applications, wherein the indication of the application is a selection of the application from the list of known applications.

3. The computer implemented method of claim 1, wherein the historical indicator is associated with a package, the package including the application and the set of files.

4. The computer implemented method of claim 1, wherein the metadata is a data structure, the data structure indicating that the application has accessed the set of files.

5. The computer implemented method of claim 4, the data structure further comprising a linked list.

6. The computer implemented method of claim 1, the historical indicator comprising a path address for the application, the path address being stored in a definition file.

7. The computer implemented method of claim 1, wherein the step of identifying the historical indicator within metadata of the set of files comprises:
parsing the metadata of a plurality of files within an electronic storage to identify the historical indicator within metadata of the set of files, wherein the set of files is identified from the plurality of files stored in the electronic storage.

8. The computer implemented method of claim 1, wherein the step of identifying the set of files associated with the metadata indicator comprises:
parsing a directory to identify the historical indicator within metadata of the set of files, wherein the set of files is identified from a plurality of files in the directory.

9. A data processing system comprising:
a bus;
a communications unit connected to the bus;
a storage device connected to the bus, wherein the storage device includes computer usable program code; and
a processor unit connected to the bus, wherein the processor unit executes the computer usable program code to receive a set of backup parameters, wherein the set of backup parameters comprises an indication of the application, responsive to receiving the set of backup parameters, to identify a historical indicator within metadata of the set of files, wherein the historical indicator indicates that the application has accessed the set of files, and to forward the set of files and the application to a backup storage.

10. The data processing system of claim 9, wherein the processor unit executing the computer usable program code to receive a set of backup parameters further comprises executing the computer usable program code to receive the set of backup parameters wherein the backup parameters comprise a list of known applications, wherein the indication of the application is a selection of the application from the list of known applications.

11. The data processing system of claim 9, wherein the processor unit executing the computer usable program code to identify the historical indicator within the metadata of the set of files further comprises executing the computer usable program code to identify the historical indicator, wherein the historical indicator is associated with a package, the package including the application and the set of files.

12. The data processing system of claim 9, wherein the processor unit executing the computer usable program code to identify the historical indicator within the metadata of the set of files further comprises executing the computer usable program code to identify the historical indicator, wherein the metadata is a data structure, the data structure indicating that the application has accessed the set of files.

13. A computer program product comprising:
a computer readable medium having computer usable program code for backing-up an application and a file for the application, the computer program product comprising:
computer usable program code for receiving a set of backup parameters, wherein the set of backup parameters comprises an indication of the application;
computer usable program code, responsive to receiving the backup parameters, identifying a historical indicator within metadata of the set of files, wherein the historical indicator indicates that the application has accessed the set of files; and
computer usable program code for forwarding the set of files and the application to a backup storage.

14. The computer program product of claim 13, wherein the computer usable program code for receiving the set of backup parameters further comprises:
computer usable program code for receiving the set of backup parameters, the set of backup parameters comprising a list of known applications, wherein the indication of the application is a selection of the application from the list of known applications.

15. The computer program product of claim 13, the computer usable program code for identifying the historical indicator within the metadata of the set of files further comprises computer usable program code for identifying the historical indicator within the metadata of the set of files, wherein the historical indicator is associated with a package, the package including the application and the set of files.

16. The computer program product of claim 13, wherein the computer usable program code for identifying the historical indicator within the metadata of the set of files further comprises computer usable program code for identifying the historical indicator from a data structure, the data structure indicating that the application has accessed the set of files.

17. A computer implemented method for managing historical access for a file, the computer implemented method comprising:
associating the file with a metadata;
responsive to an application accessing the file, appending a historical identifier to the metadata, wherein the historical indicator indicates that the application has accessed the file.

18. The computer implemented method of claim 17, wherein the historical indicator is associated with a package, the package including the application and the file.

19. The computer implemented method of claim 17, wherein the metadata is a data structure, and the historical indicator comprising a path address for the application, the path address being stored in a definition file.

20. The computer implemented method of claim 19, the data structure further comprising a linked list.
